(19) United States
(12) Patent Application Publication
(10) Pub. No.: US 2024/0404003 A1
(43) Pub. Date: Dec. 5, 2024

(54) INSTANCE SEGMENTATION WITH DEPTH AND BOUNDARY LOSSES

(71) Applicant: QUALCOMM Incorporated, San Diego, CA (US)

(72) Inventors: Debasmit DAS, San Diego, CA (US); Hyojin PARK, San Diego, CA (US); Shubhankar Mangesh BORSE, San Diego, CA (US); Yu FU, Taipei City (TW); Oleksandr BAILO, Amstelveen (NL); Mohsen GHAFOORIAN, Diemen (NL); Fatih Murat PORIKLI, San Diego, CA (US)

(21) Appl. No.: 18/326,437

(22) Filed: May 31, 2023

(51) Int. Cl. G06T 3/40

(52) U.S. Cl. CPC G06T 3/4046

(57) ABSTRACT

Certain aspects of the present disclosure provide techniques for training and using an instance segmentation neural network to detect instances of a target object in an image. An example method generally includes generating, through an instance segmentation neural network, a first mask output from a first mask generation branch of the network. The method further includes generating, through the instance segmentation neural network, a second mask output from a second, parallel, mask generation branch of the network. The second mask output is typically of a lower resolution than the first mask output. The method further includes combining the first mask output and second mask output to generate a combined mask output. Based on the combined mask output, an output of the instance segmentation neural network is generated. One or more actions are taken based on the generated output.

### INTRODUCTION

Aspects of the present disclosure relate to using trained artificial neural networks to detect instances of target objects in visual content.

Object detection methods coarsely identify multiple objects in images by drawing boundaries around these objects. Semantic segmentation methods create pixel-level categories for object classes and assign a category to the pixels associated with the identified objects in an image. Instance segmentation methods combine object detection and semantic segmentation by generating a segment map for each type of detected object. Instances of each object may be localized from all possible classes. That is, while object detection typically finds bounding boxes around objects and classifies these objects, instance segmentation adds, for every detected object, a pixel mask that gives the shape of the object.

Some target objects, such as humans, can be found in any number of environments. However, the training data sets used to train instance segmentation neural networks may include data from different environments from a production environment in which instance segmentation neural networks are deployed. As such, the resulting instance segmentation neural networks may not be able to accurately detect instances of target objects in images taken in all potential environments. For example, these instance segmentation neural networks may not accurately identify boundaries around specific instances of an object, which may adversely affect applications that rely on the detection of instances of objects in order to perform some downstream action (e.g., controlling vehicles in autonomous driving applications, rendering scenes in extended reality applications, and so on).

Accordingly, what is needed are improved techniques for identifying instances of objects in images using instance segmentation neural networks.

### BRIEF SUMMARY

Certain aspects provide a method for detecting a target object in an image using an artificial neural network. An example method generally includes generating, through a segmentation neural network, a first mask output from a first mask generation branch of the segmentation neural network. A second mask output is generated from a second mask generation branch of the segmentation neural network. The second mask generation branch has a lower resolution than the first mask generation branch. A combined mask output is then generated based on the first mask output and the second mask output. Based on the combined mask output, an output of the segmentation neural network is generated. One or more actions are then taken based on the generated output.

Certain aspects provide a method for training an artificial neural network to detect target objects in an image. An example method generally includes generating a set of labels for an unlabeled training data set. An instance segmentation neural network is trained based on the generated set of labels. Generally, the instance segmentation neural network includes at least a first mask generation branch and a second mask generation branch, the second mask generation branch having a lower resolution than the first mask generation branch.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of aspects of the present disclosure and are therefore not to be considered limiting of the scope of this disclosure.

FIG. 1 depicts an example architecture of a neural network used to generate labeled training data for training an instance segmentation neural network.

FIG. 2 depicts an example architecture of an instance segmentation neural network.

FIG. 3 depicts example operations for detecting instances of objects in an image using an instance segmentation neural network, according to aspects of the present disclosure.

FIG. 4 depicts example operations for training an instance segmentation neural network, according to aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques and apparatus for accurately detecting instances of objects and boundaries of these instances of objects using instance segmentation neural networks.

In a segmentation neural network, pixels of an image can be grouped together, based on similarity of the pixels. Semantic segmentation neural networks may use deep learning algorithms to associate a label or category with every pixel of an image, so that collections of pixels that form distinct categories can be recognized. Instance segmentation neural networks detect instances of an object in an image, and may also demarcate the boundaries of the object. Thus, each distinct object of interest appearing in an image can be detected and delineated.

Accuracy of a segmentation neural network is often dependent upon the strength of the training data set. When deploying a segmentation neural network in a real world setting different from that of the training data set, the neural network may not accurately detect boundaries of a target object (e.g., the boundaries of a human identified in an image).

When the segmentation neural network is deployed to different environments, additional environment-specific training data sets may be used in training the segmentation neural network. Oftentimes, however, some or all of the training data sets consist of unlabeled data. Unlabeled data is easier (compared to labeled data) to acquire and store, but may have more limited usefulness since unlabeled data can be used for unsupervised learning, but generally may not be used for supervised learning.

Due to deployment of a segmentation neural network in different real world environments, and unavailability of sufficient labeled training data sets for each of the specific environments, the present disclosure provides for techniques for generating pseudo-labels on the unlabeled data to train an instance segmentation neural network.

As discussed in further detail herein, unlabeled data may be annotated with pseudo-labels to generate a noisy output. Subsequently, extra loss functions and parallel branches may be utilized in a neural network to improve the accuracy of a trained instance segmentation neural network without significantly increasing latency or computation complexity. Each of these components are discussed in further detail below.

The instance segmentation neural network described herein may have many applications. For example, in autonomous vehicle applications, typical models are trained on clean real datasets or simulated game datasets. The techniques described herein can be useful for generalization to real-world scenes where accurate human segmentation masks along with depth will allow the vehicle to take appropriate control actions, e.g., velocity control, steering, and/or braking.

Additionally, in robotic applications, accurate human instance segmentation enables a variety of capabilities in human-robot interactions, such as navigation, localization, and interaction with physical objects in the environment. These instance segmentation neural networks can further be used to tackle domain-shift characteristics between source datasets and target datasets, such as changes in human characteristics, and changes in the surrounding environment.

Further, in extended reality (XR) applications, accurate human segmentation may be utilized for use cases such as human occlusion rendering and semantic reconstruction. The indoor environment on which the segmentation models are trained will typically have different characteristics than the deployed environments. There might be changes in layout, brightness, etc. In such situations, training on the unlabeled test dataset may be performed to encounter the domain shift of the pre-training dataset and test dataset.

### Labeling an Unlabeled Training Data Set

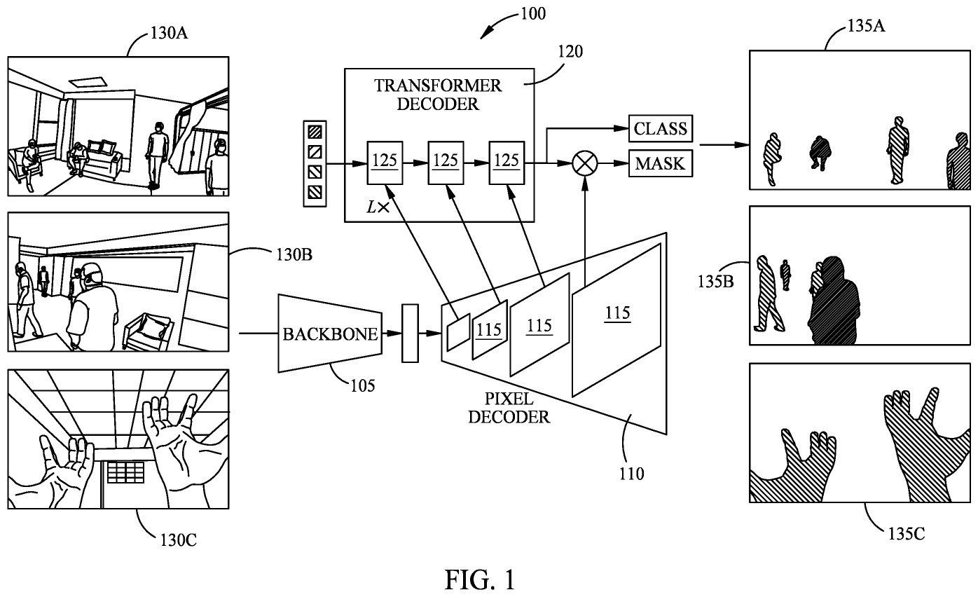

FIG. 1 depicts an example architecture for a mask transformer for instance segmentation. In example aspects, the architecture is a Mask2Former architecture. While per-pixel classification architectures based on fully convolutional networks (FCNs) are generally used for semantic segmentation, mask classification architectures that predict a set of binary masks, each associated with a single category, are typically used for instance segmentation.

Mask classification architectures may group pixels into N segments by predicting N binary masks, along with N corresponding category labels. In example architecture 100 of FIG. 1, a backbone 105 may extract low-resolution features from an input image, such as input images 130A, 130B, and 130C of FIG. 1. A pixel decoder 110 may gradually upsample low-resolution features from the output of the backbone 105 to generate high-resolution per-pixel embeddings. A transformer decoder 120 may operate on image features to process object queries. The final binary mask predictions may be decoded from the per-pixel embeddings with object queries.

Transformer decoder 120 of FIG. 1 includes a masked attention operator, which may extract localized features by constraining cross-attention to within the foreground region of the predicted mask for each query, instead of attending to the full feature map. In some aspects, successive feature maps 115 from the pixel decoder's feature pyramid are fed into successive transformer decoder layers 125 in a round-robin fashion. In other aspects, feature maps 115 may be processed by transformer decoder layers 125 in a sequence other than round robin.

High-resolution features generally improve model performance, especially for small objects. However, using high-resolution features is computationally demanding. As such, architecture 100 may utilize a feature pyramid which consists of both low- and high-resolution features, and may feed a feature map 115 of the multi-scale features at a specific resolution to one transformer decoder layer 125 at a time. In some examples, the feature pyramid produced by the pixel decoder 110 may have three layers of resolution 1/32, 1/16, and ⅛ of the original image. Each of these layers may be used, from lowest resolution to highest resolution, for the corresponding transformer decoder layer 125. In some examples, this three-layer transformer decoder can be repeated L times. In this case, the final transformer decoder 120 has 3L layers. The first three layers 125 may receive a feature map of resolution H₁=H/32, H₂=H/16, H₃=H/8 and W₁=W/32, W₂=W/16, and W₃=W/8, where H and W are the height and width dimensions, respectively, of the original image resolution. This pattern may be repeated in a round-robin fashion for all following layers. In other examples, more or less than three different resolutions may be used, such that transformer decoder 120 can have fewer than three layers, or more than three layers.

In aspects of architecture 100, query features are learnable, and are directly supervised before being used in the transformer decoder 120 to predict masks. These learnable query features function like a region proposal network (e.g., a convolutional neural network that predicts object locations and generates scores indicative of whether an object is located at a given position in an image) and have the ability to generate mask proposals, such as those depicted in output images 135A-C of FIG. 1. As shown in output images 135A-C, instances of humans have been detected, but the masks are noisy and thus the human instances detected are imprecise and error-prone, particularly around the boundaries. In addition, an output of transformer decoder 120 may be a classification label for each image of the training data set. As used herein, the generated classification label is sometimes referred to as a pseudo-label.

### Example Instance Segmentation Neural Network Architecture

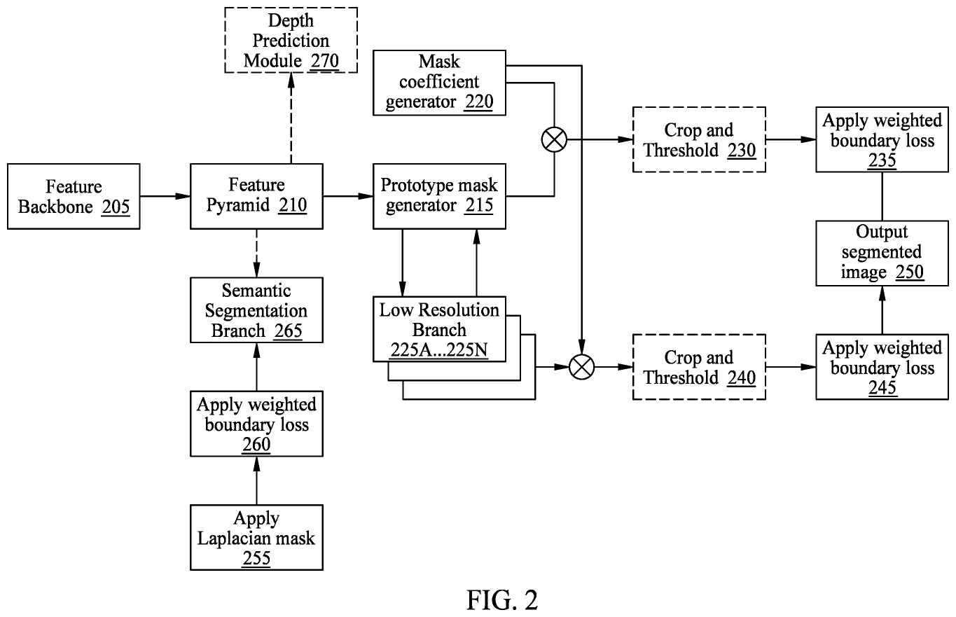

FIG. 2 depicts an example architecture 200 of an instance segmentation neural network. In some examples, the architecture 200 is implemented by a convolutional neural network based on a YOLACT (You Only Look At CoefficienTs) network. Architecture 200 uses two parallel subtasks: (1) generating a set of prototype masks, and (2) predicting per-instance mask coefficients. Further, the subtask of generating a set of prototype masks is itself composed of parallel branches, each parallel branch producing prototype masks of differing resolutions. Instance masks may be produced by linearly combining the prototypes with the mask coefficients. Using architecture 200, instance segmentation can be achieved with increased accuracy and in substantially real time, without using feature localization, or “repooling” of features in a bounding box region.

Architecture 200 uses one branch to generate a dictionary of non-local prototype masks over the entire image, and another parallel branch to predict a set of linear combination coefficients per instance. Then, the prototypes may be linearly combined using the corresponding predicted coefficients. Optionally, the prototypes can be cropped with a predicted bounding box. By segmenting in this manner, the network learns how to localize instance masks on its own, where visually, spatially, and semantically similar instances appear different in the prototypes.

Because of the parallel structure of architecture 200, the neural network is fast, and can execute in a matter of milliseconds. Further, the masks produced are of a high quality, since the masks use the full extent of the image space without any loss of quality from repooling.

In one branch of the segmentation neural network of FIG. 2, one branch uses a FCN to produce a set of image-sized prototype masks that do not depend on any specific instance. Another branch predicts a vector of mask coefficients for each anchor that encode an instance's representation in the prototype space. Finally, a mask is constructed for each instance by linearly combining the work of the multiple branches in the neural network.

In aspects of the present disclosure, instance segmentation is performed in this way in part because masks are spatially coherent. That is, pixels close to each other are likely to be part of the same instance. While a convolutional layer naturally takes advantage of this coherence, a fully connected layer does not. Thus, architecture 200 relies on parallel branches. In some aspects, a fully connected layer is used to produce the mask coefficients, since a fully connected layer is good at producing semantic vectors, while one or more convolutional layers are used to produce the prototype masks, since convolutional layers are good at producing spatially coherent masks. Thus, prototypes and mask coefficients are computed independently in architecture 200, and the computational overhead comes mostly from the assembly process, which can be implemented as a single matrix multiplication. In this way, spatial coherence in the feature space can be maintained while still being fast.

In architecture 200 of FIG. 2, an input image may be first processed by a feature backbone 205. In some examples, feature backbone 205 may be a convolutional neural network that serves as a feature extractor for features of the input image. In some aspects, feature backbone 205 may be of a VGG (Visual Geometry Group), ResNet (residual neural network), or Inception architecture, amongst others.

The extracted features may then be processed by feature pyramid 210, which combines the features from different levels of the convolutional network, in order to better detect objects at different scales. From feature pyramid 210, prototype mask generator 215 may predict a set of k prototype masks for the entire image. In some aspects, prototype mask generator 215 is implemented as an FCN whose last layer has k channels (one for each prototype). While this formulation is similar to standard semantic segmentation, it differs in that no loss is exhibited on the prototypes. Instead, all supervision for the prototypes comes from the final mask loss after assembly.

By generating prototype masks from deeper backbone features, more robust masks can be produced. Further, higher resolution prototypes result in both higher quality masks and better performance on smaller objects.

In some aspects, an output of the prototype mask generator 215 is unbounded, to allow the network to produce large, overpowering activations for prototypes it is very confident about, such as obvious background. Thus, optionally, an output of prototype mask generator 215 can be processed by a further linear or nonlinear activation layer, such as a Rectified Linear Unit (ReLU) layer.

In parallel to the prototype mask generator 215, there are one or more low-resolution branches 225A-225N. In various aspects, each of the low-resolution branches 225A-225N may include one or more convolutional layers, and each generates a lower resolution mask than prototype mask generator 215. Higher resolution masks are typically more susceptible to boundary errors, and thus by combining one or more lower resolution branches in parallel to the higher resolution prototype mask generator branch, the accuracy of the mask boundaries can be increased.

A number of low resolution branches present in architecture 200 can be variable, depending on the variation in types of objects in the image, size of objects in the images, and computational processing capability available. To identify smaller objects, higher resolution branches lead to better accuracy of the network. Further, downsizing the resolution for a small object too much may cause the object to disappear entirely from the image or be reduced to simply one pixel. However, for larger objects, lower resolution branches are sufficient for detecting the instance of the object in the image. In addition, processing capability (e.g., of devices on which a neural network constructed according to architecture 200 is deployed) may constrain a number of low resolution branches that can be available in architecture 200.

For example, the prototype mask generator 215 may generate a mask of resolution 112×112. A first low resolution branch may generate a mask of 56×56 resolution, a second low resolution branch may generate a mask of 28×28 resolution, and a third low resolution branch may generate a mask of 12×12 resolution. In other examples, other resolutions are used.

An output of each of low-resolution branches 225A-225N are then upsampled to a common resolution, so that the output of the low-resolution branches 225A-225N can be combined with a (higher resolution) output of prototype mask generator 215, to generate a combined mask output. In some examples, the mask outputs are combined by a concatenation operation to generate the combined mask output at the higher resolution. In this way, one combined mask is generated for each instance of each object in the image. However, both the lower and higher resolution masks can be used for the supervision of the neural network, in example aspects.

Mask coefficient generator 220 of architecture 200 is used to generate coefficients that are used with each of the generated masks from prototype mask generator 215 and low-resolution branches 225A-225N. In some examples, mask coefficient generator 220 may predict a mask coefficient corresponding to each prototype. In other examples, mask coefficient generator 220 may predict a mask coefficient corresponding to each prototype generated from the prototype mask generator 215 only. The generated mask coefficients are multiplied with each prototype mask to generate a mask output.

To produce a mask for each identified instance of a target object in an image, an output of each of the parallel branches of architecture 200 may be combined. That is, in an upper branch of architecture 200, coefficients from mask coefficient generator 220 may be multiplied with an output from prototype mask generator 215 to generate a first mask output. Optionally, this first mask output can undergo a cropping and/or thresholding operation at block 230, to crop a region around a predicted bounding box. A weighted boundary loss may be applied to the first mask output at block 235.

In a parallel lower branch of architecture 200, coefficients from mask coefficient generator 220 may be multiplied with an output from each of low-resolution branches 225A-225N to generate a second mask output. Optionally, this second mask output can undergo a cropping and/or thresholding operation at block 240. A weighted boundary loss may be applied to the second mask output at block 245. At block 250, the segmented image may be output, depicting the identified instance(s) of the target object(s) in the image.

To improve accuracy around the boundaries of an identified instance of an object, a loss function may be applied on the combined mask output, while additional loss functions may be applied to each of the low-resolution branches.

In some aspects, at least four loss functions are used to train the instance segmentation neural network of FIG. 2 based on a generated set of pseudo-labels: a classification loss, mask loss, box regression loss, and boundary loss. In some aspects, the instance segmentation neural network is trained to minimize a mask loss for an input image of the unlabeled training data set, where the mask loss is determined according to the following equation: Lₘₐₛₖ=BCE(M, M_{gt}), where Lₘₐₛₖ is the mask loss, BCE( ) represents a binary cross entropy function, M represents a mask, and M_{gt} represents a ground truth mask. Thus, to compute mask loss, a pixel-wise binary cross entropy is taken between assembled masks M and the ground truth masks M_{gt}. In some aspects, the mask loss may be applied after the weighted boundary loss is applied at blocks 235 and 245 of architecture 200 of FIG. 2.

In other aspects, the instance segmentation neural network is trained to minimize a box regression loss for an input image of the unlabeled training data set, where the box regression loss is determined according to the following equation:

$${L}_{box} = F ( {B}_{pred} , {B}_{gt} )$$

where: L_{box} is the box regression loss, F( ) represents a loss function of the second mask generation branch, B_{pred} represents a predicted box regression, and B_{gt} represents a ground truth box regression. In some aspects, the box regression loss may be applied as part of the cropping and thresholding operations at blocks 230 and 240 of architecture 200 of FIG. 2.

In other aspects, the instance segmentation neural network is trained to minimize a classification loss for an input image of the unlabeled training data set, the classification loss determined according to the equation:

$${L}_{cls} = C E ( {Y}_{pred} , {Y}_{gt} )$$

where: L_{cls} is the classification loss, CE( ) is a cross entropy function, Y_{pred} is a predicted classification, and Y_{gt} is a ground truth classification. In some aspects, the classification loss may be applied as part of the generation of the pseudo-labels, as depicted in FIG. 1.

In addition, the instance segmentation neural network may be trained to minimize a boundary loss for an input image of the unlabeled training data set, the boundary loss determined according to the equation:

$${L}_{bnd} = B C E ( M , {M}_{gt} , W )$$

where: L_{bnd} is the boundary loss, BCE( ) is a binary cross entropy function, M represents an output mask, M_{gt} is a ground truth mask, and W is a weight on each pixel of the input image. In some aspects, the boundary loss may be applied during the application of weighted boundary loss at blocks 235 and 245 of architecture 200 of FIG. 2.

An output of feature pyramid 210 of architecture 200 is optionally processed by a semantic segmentation branch 265. Because pseudo-labels are used for the unlabeled training data set (as described with respect to FIG. 1), the predicted boundaries are noisy and error prone. As such, pixels representing the boundary of the target instance may most likely be weighed more in computing the mask loss. The weight of each pixel can be found by applying the Laplacian operation on a ground truth mask at block 255 of architecture 200, which produces weights that are highest in value on the boundary of the target instance, and lowest in value farther away from the boundary of the target instance. The weighted boundary loss may be applied at block 260, and processed by semantic segmentation branch 265.

Architecture 200 of FIG. 2 optionally has a depth prediction module 270. In some aspects, depth prediction module 270 can be used without the low-resolution branches 225A-225N. Depth prediction helps ordering of different objects and can help instance segmentation through multi-task learning. In some aspects, depth prediction module 270 is a 1×1 convolutional block in communication with feature pyramid 210. In other aspects, depth prediction module 270 is in communication with the largest feature map from feature pyramid 210. Depth prediction module 270 applies an L2/L1 regression loss to generate pseudo-ground truths. These pseudo-ground truths can enhance accuracy during training of the instance segmentation neural network.

With the additional depth prediction module 270, the boundary cross entropy loss is applied at multiple locations in architecture 200. That is, at the feature pyramid 210 and also in the generation of the final segmented output image. In other example aspects, the boundary cross entropy loss can be applied at a different or additional location in architecture 200 of FIG. 2.

Thus, the instance segmentation neural network is trained to minimize a boundary mask loss for an input image of the training data set, according to the following equation: Lₘₐₛₖ=BCE(M_{pd},M_{gt′})+λBCE(M_{pd}^{sel}, M_{gt}^{sel}), where: Lₘₐₛₖ is the boundary mask loss, BCE( ) is a binary cross entropy function, M_{pd} represents an output mask for all predicted pixels of the input image, Met is a ground truth mask for all ground truth pixels of the input image, M_{pd}^{sel} represents a mask for selected predicted pixels, and M_{gt}^{sel} represents selected ground truth pixels for the ground truth mask. In some example aspects, the selected predicted pixels (SPP) may be the boundary pixels of a predicted mask, while the selected ground truth pixels (SGP) may be the boundary pixels of the ground truth mask.

The boundary mask loss may further have multiple modes. In a first example mode, SPP and SGP may be used as represented in the equation. In a second example mode, a union of SPP and SGP may be used in the binary cross entropy function of the equation. That is, a union of the boundary pixels of both the ground truth mask and the predicted mask may be used. In a third example mode, an intersection of SPP and SGP may be used in the binary cross entropy function of the equation. That is, an intersection of boundary pixels of the ground truth mask and a predicted mask may be used to determine the boundary mask loss.

In some aspects, depth prediction module 270 may be further trained to minimize a depth prediction loss for a predicted mask D_{pred}. The depth prediction loss may be minimized during training via supervised learning from one or more pseudo-ground truth depths D_{pseudo}. Before training the neural network, a depth estimation network (not depicted) generally produces a pseudo-ground truth depth, D_{pseudo}, for each input image in a training data set. From the generated D_{pseudo} for each input image in the training data set, depth prediction module 270 can be trained to minimize a depth prediction loss, L_{depth}, based on D_{pred} and D_{pseudo}. The depth prediction loss may thus be a function of the depth prediction for a predicted mask, and the pseudo-ground truth depth. In some aspects, depth prediction loss L_{depth} can be an L1 loss or an L2 loss.

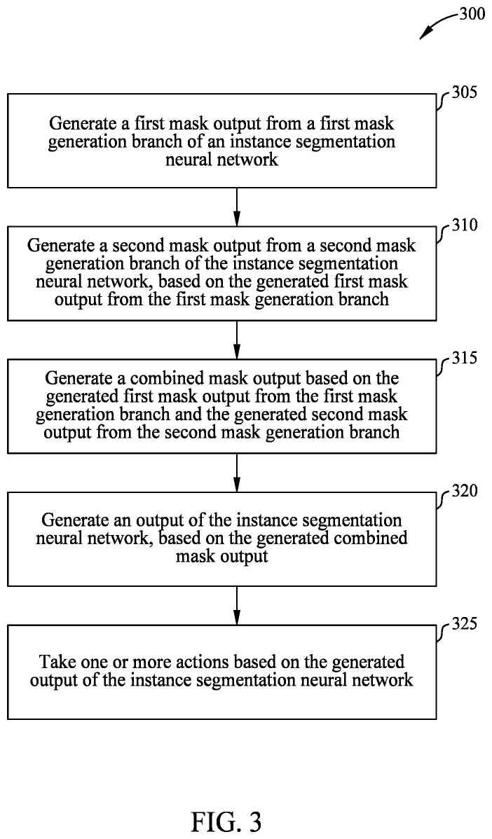

FIG. 3 is a flow diagram depicting an example method 300 for performing an inference with an instance segmentation neural network, according to aspects of the present disclosure. The method can be performed by a device on which an instance segmentation neural network, such as that depicted in FIG. 2, is deployed, such as a mobile phone, an autonomous vehicle, or other devices which can process captured imagery in order to detect instances of objects in the captured imagery.

At block 305 of method 300, an inferencing system generates a first mask output from a first mask generation branch (such as from prototype mask generator 215 of FIG. 2) of an instance segmentation neural network.

In some aspects, at least part of the instance segmentation neural network is a convolutional neural network. In some aspects, the instance segmentation neural network is based on a YOLACT (You Only Look At CoefficientTs) neural network. An input to the instance segmentation neural network may comprise an input image for object detection.

At block 310 of method 300, the inferencing system generates a second mask output from a second mask generation branch (such as from one or more low-resolution branches 225A-225N of FIG. 2) of the instance segmentation neural network. As discussed herein, the second mask output may be based on the generated first mask output from the first mask generation branch. Further, as discussed herein, the second mask output has a lower resolution than the first mask output.

In some aspects, the generated second mask output from the second mask generation branch is based on at least one mask coefficient determined (e.g., from mask coefficient generator 220 of FIG. 2) for the first mask generation branch of the instance segmentation neural network.

While not expressly depicted in FIG. 3, in some aspects, method 300 further includes generating a third mask output from a third mask generation branch, where the third mask generation branch has a lower resolution than the second mask generation branch. The third mask generation branch may be a further low-resolution branch (such as low-resolution branches 225A-225N of FIG. 2).

At block 315 of method 300, the inferencing system generates a combined mask output based on the generated first mask output from the first mask generation branch and the generated second mask output from the second mask generation branch. The combined mask output may, in some aspects, be generated by concatenating the first mask output with the second mask output. The generated combined mask output comprises a mask for each instance of a target object identified in an input image by the instance segmentation neural network.

In order to generate the combined mask output, the (lower resolution) second mask output may be first upsampled to a same resolution as the first mask output. If a third mask output is also generated from a third mask generation branch, then the inferencing system may generate a combined mask output based on the generated first, second, and third mask outputs. Further, both the second and third mask outputs are upsampled to a same resolution as the first mask output in order to generate the combined mask output. In some aspects, the inferencing system further generates a predicted bounding box around a target object in an image based on the combined mask output.

While not expressly depicted in FIG. 3, in some aspects, the inferencing system further generates an output from a semantic segmentation branch of the instance segmentation neural network (such as semantic segmentation branch 265 of FIG. 2). The output from the semantic segmentation branch identifies portions of the input for which the instance segmentation neural network is to generate the combined mask output. In other aspects, the inferencing system may further generate a depth prediction (such as from depth prediction module 270 of FIG. 2). The depth prediction may be based at least in part on minimizing a boundary mask loss, as represented by the equation discussed above with respect to FIG. 2.

At block 320 of method 300, the inferencing system generates an output of the instance segmentation neural network, based on the generated combined mask output. The output of the instance segmentation neural network may be the input image with the identified instance(s) of the target object(s) identified in any manner. In some aspects, the generated output of the instance segmentation neural network comprises a boundary of at least one instance of a target object in the input image. In some aspects, the output further includes a predicted bounding box around the target object(s). The identified instances may be shaded or outlined with one or more colors. In some aspects, each identified instance of a target object is depicted in a unique manner. In other aspects, each target object is depicted in a unique manner. In some aspects, the target object is a human person. In other aspects, the target object is another animate or inanimate entity.

In some aspects, the inferencing system generates the output of the instance segmentation neural network by minimizing one or more of a mask loss, box regression loss, classification loss, or boundary loss, as determined by the equations discussed above with respect to FIG. 2.

At block 325 of method 300, the inferencing system takes one or more actions based on the generated output of the instance segmentation neural network, which may include the predicted bounding box, in some instances. The one or more actions may include displaying the output on a hardware device, such as a portable user device, or other computing device.

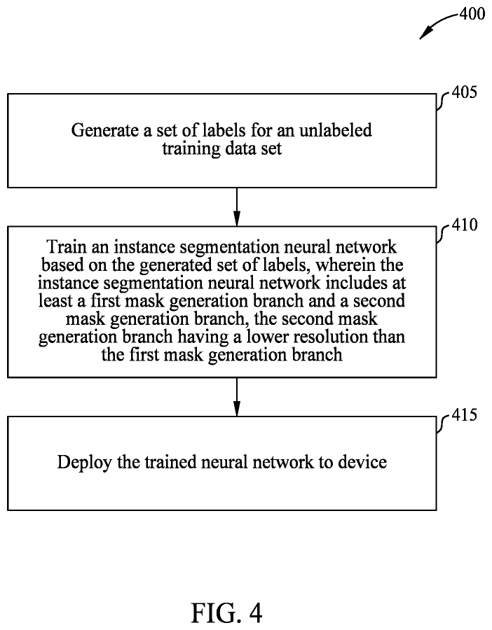

FIG. 4 is a flow diagram depicting an example method 400 for training an instance segmentation neural network. In some aspects, method 400 is used to train the instance segmentation neural network depicted in architecture 200 of FIG. 2. Further, in some aspects, method 400 is performed to provide offline training of one or more neural network, such as by a training device or system.

At block 405 of method 400, the training system generates a set of labels for an unlabeled training data set. In some aspects, the set of labels may be generated using a transformer neural network trained to generate a mask and a classification for objects in images, such as that represented by architecture 100 of FIG. 1. As discussed herein, the labels may be pseudo-labels generated for an unlabeled training data set.

At block 410 of method 400, the training system trains the instance segmentation neural network based on the generated set of labels. As discussed herein, the instance segmentation neural network may be similar to that depicted in architecture 200 of FIG. 2, and include at least a first mask generation branch (prototype mask generator 215) and a second mask generation branch (low-resolution branches 225A-225N). The second mask generation branch may have a lower resolution than the first mask generation branch.

In some aspects, the training the instance segmentation neural network based on the generated set of labels comprises training the network to minimize a weighted boundary loss on a boundary of a target object in an input image of the (unlabeled) training data set).

Further, the training of the instance segmentation neural network may comprise training the network to minimize one or more of a mask loss, a box regression loss, a classification loss, or a boundary loss for an input image of the training data set. Each of these losses may be determined in accordance with the equations discussed above with respect to FIG. 2. The training of the instance segmentation neural network may further comprise training the network to minimize a loss of a Laplacian filter applied to a ground truth mask.

In some aspects, the instance segmentation neural network may be further trained to minimize a boundary mask loss via a depth prediction module (such as depth prediction module 270 of FIG. 2), in accordance with the equation discussed above with respect to FIG. 2.

At block 415 of method 400, the training system deploys the trained instance segmentation neural network to a hardware device, such as proprietary hardware, a portable user device, or any other hardware device.

### Example Processing System

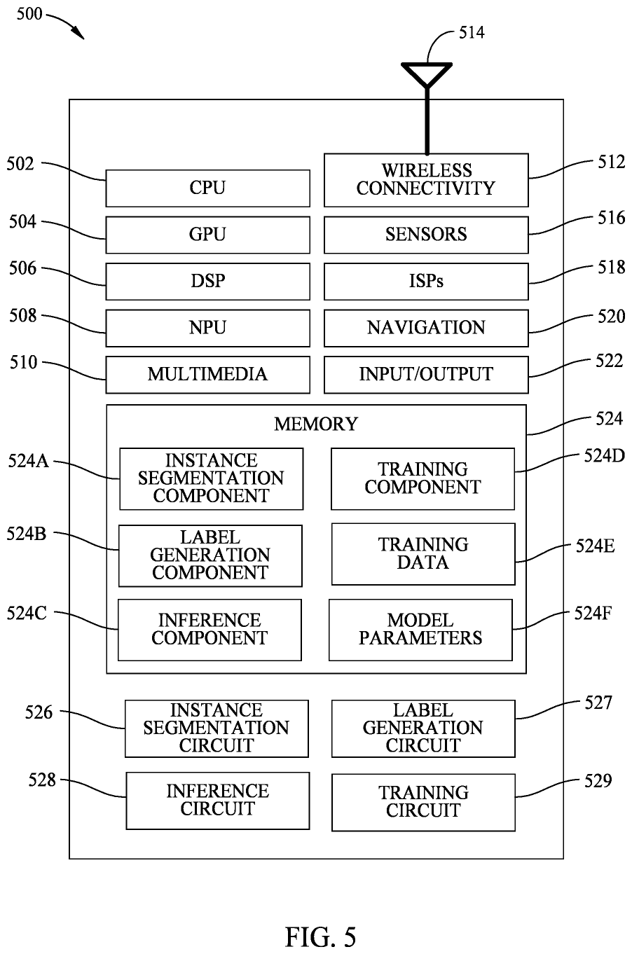

In some aspects, the workflows, techniques, and methods described with reference to FIGS. 1-4 may be implemented on one or more devices or systems. FIG. 5 depicts an example processing system 500 configured to perform various aspects of the present disclosure, including, for example, the techniques and methods described with respect to FIGS. 1-4. In some aspects, the processing system 500 may correspond to a computing system that trains machine learning models (e.g., a training system) and/or to a computing system that uses the trained models for inferencing (e.g., an inferencing system).

In some aspects, the processing system 500 corresponds to a base station and/or to user equipment engaged in wireless communication. Although depicted as a single system for conceptual clarity, in at least some aspects, as discussed above, the operations described below with respect to the processing system 500 may be distributed across any number of devices. For example, a first system may train the model(s) while a second system uses the trained models to generate channel estimations (and take an action based thereon).

Processing system 500 includes a central processing unit (CPU) 502, which in some examples may be a multi-core CPU. Instructions executed at the CPU 502 may be loaded, for example, from a program memory associated with the CPU 502 or may be loaded from a memory 524.

Processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as NPU 508, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 508, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples, the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and/or biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, NPU 508 is a part of one or more of CPU 502, GPU 504, and/or DSP 506.

In some examples, wireless connectivity component 512 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and/or other wireless data transmission technologies. Wireless connectivity component 512 is further coupled to one or more antennas 514.

Processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS) as well as inertial positioning system components.

Processing system 500 may also include one or more input and/or output devices 522, such as screens, touch-sensitive surfaces (including touch-sensitive displays), physical buttons, speakers, microphones, and the like.

In some examples, one or more of the processors of processing system 500 may be based on an ARM or RISC-V instruction set.

Processing system 500 also includes memory 524, which is representative of one or more static and/or dynamic memories, such as a dynamic random access memory, a flash-based static memory, and the like. In this example, memory 524 includes computer-executable components, which may be executed by one or more of the aforementioned processors of processing system 500.

In particular, in this example, memory 524 includes instance segmentation component 524A, label generation component 524B, inference component 524C, and a training component 524D. The memory 524 also includes a set of training data 524E and model parameters 524F. The model parameters 524F may generally correspond to the parameters of all or a part of a trained instance segmentation neural network, such as one or more weights and biases used for one or more layers of a neural network, as discussed above. The training data 524E generally corresponds to the training samples or exemplars for training the neural network, such as the training samples and ground truth data. The depicted components, and others not depicted, may be configured to perform various aspects of the techniques described herein. Though depicted as discrete components for conceptual clarity in FIG. 5, instance segmentation component 524A, label generation component 524B, inference component 524C, and training component 524D may be collectively or individually implemented in various aspects.

Processing system 500 further comprises instance segmentation circuit 526, label generation circuit 527, inference circuit 528, and training circuit 529. The depicted circuits, and others not depicted, may be configured to perform various aspects of the techniques described herein.

For example, instance segmentation component 524A and instance segmentation circuit 526 may be used for training and/or inference of the instance segmentation neural network, as discussed above with reference to FIGS. 1-4. Label generation component 524B and label generation circuit 527 may be used to generate labels for the training data set, such as discussed above with reference to FIG. 1. Inference component 524C and inference circuit 528 may be used to orchestrate the processing of data in the neural network and/or to generate the final output of the neural network (during training and/or during inferencing), as discussed above with reference to FIGS. 1-4. Training component 524D and training circuit 529 may be used to compute losses and/or to refine the neural network, as discussed above with reference to FIGS. 1-4.

Though depicted as separate components and circuits for clarity in FIG. 5, instance segmentation circuit 526, label generation circuit 527, inference circuit 528, and training circuit 529 may collectively or individually be implemented in other processing devices of processing system 500, such as within CPU 502, GPU 504, DSP 506, NPU 508, and the like.

Notably, in other aspects, aspects of processing system 500 may be omitted, such as where processing system 500 is a server computer or the like. For example, multimedia processing unit 510, wireless connectivity component 512, sensor processing units 516, ISPs 518, and/or navigation processor 520 may be omitted in other aspects. Further, aspects of processing system 500 may be distributed between multiple devices, such as one device for training a model and a second device to generate inferences.

Generally, processing system 500 and/or components thereof may be configured to perform the methods described herein.

### Example Clauses

Implementation examples are described in the following numbered clauses.
Clause 1: A processor-implemented method comprising: generating a first mask output from a first mask generation branch of an instance segmentation neural network, based on an input to the instance segmentation neural network; generating a second mask output from a second mask generation branch of the instance segmentation neural network, based on the generated first mask output from the first mask generation branch, the second mask generation branch having a lower resolution than the first mask generation branch; generating a combined mask output based on the generated first mask output from the first mask generation branch and the generated second mask output from the second mask generation branch; generating an output of the instance segmentation neural network, based on the generated combined mask output; and taking one or more actions based on the generated output of the instance segmentation neural network.
Clause 2: The method of Clause 1, wherein at least part of the instance segmentation neural network is a convolutional neural network.
Clause 3: The method of Clause 1 or 2, wherein the generated first mask output from the first mask generation branch has a higher resolution than the generated second mask output from the second mask generation branch.
Clause 4: The method of any of Clauses 1 through 3, further comprising upsampling the generated second mask output from the second mask generation branch to a same resolution as the generated first mask output from the first mask generation branch, prior to generating the combined mask output.
Clause 5: The method of any of Clauses 1 through 4, wherein the generated second mask output from the second mask generation branch is based on at least one mask coefficient determined for the first mask generation branch of the instance segmentation neural network.
Clause 6: The method of any of Clauses 1 through 5, further comprising generating a third mask output from a third mask generation branch, wherein the third mask generation branch has a lower resolution than the second mask generation branch, and wherein the combined mask output is generated further based on the generated third mask output.
Clause 7: The method of any of Clauses 1 through 6, further comprising generating a predicted bounding box around a target object in an image, prior to generating the output of the instance segmentation neural network, wherein the output includes the predicted bounding box around the target object and wherein the taking the one or more actions is further based on the predicted bounding box.
Clause 8: The method of any of Clauses 1 through 7, further comprising generating an output from a semantic segmentation branch of the instance segmentation neural network, prior to generating the output of the instance segmentation neural network, wherein the output from the semantic segmentation branch identifies portions of the input for which the instance segmentation neural network is to generate the combined mask output.
Clause 9: The method of any of Clauses 1 through 8, wherein the instance segmentation neural network is based on a YOLACT (You Only Look At CoefficientTs) neural network.
Clause 10: The method of any of Clauses 1 through 9, wherein the generating the combined mask output comprises concatenating the generated first mask output from the first mask generation branch with the generated second mask output from the second mask generation branch.
Clause 11: The method of any of Clauses 1 through 10, wherein the generated combined mask output comprises a mask for each instance of a target object identified in an input image by the instance segmentation neural network.
Clause 12: The method of any of Clauses 1 through 11, wherein the input to the instance segmentation neural network comprises an input image and wherein the generated output of the instance segmentation neural network comprises a boundary of at least one instance of a target object in the input image.
Clause 13: The method of any of Clauses 1 through 12, wherein the generating the output of the instance segmentation neural network is based on the instance segmentation neural network minimizing a mask loss, the mask loss determined according to: Lₘₐₛₖ=BCE(M, M_{gt}), where: Lₘₐₛₖ is the mask loss, BCE( ) represents a binary cross entropy function, M represents a mask, and M_{gt} represents a ground truth mask.
Clause 14: The method of any of Clauses 1 through 13, wherein the generating the output of the instance segmentation neural network is based on the instance segmentation neural network minimizing a box regression loss, the box regression loss determined according to L_{box}=F(B_{pred}, B_{gt}), where: L_{box} is the box regression loss, F( ) represents a loss function of the second mask generation branch, B_{pred} represents a predicted box regression, and B_{gt} represents a ground truth box regression.
Clause 15: The method of any of Clauses 1 through 14, wherein the generating the output of the instance segmentation neural network is based on the instance segmentation neural network minimizing a classification loss, the classification loss determined according to L_{cls}=CE(Y_{pred}, Y_{gt}), where: L_{cls} is the classification loss, CE( ) is a cross entropy function, Y_{pred} is a predicted classification, and Y_{gt} is a ground truth classification.
Clause 16: The method of any of Clauses 1 through 15, wherein the input to the instance segmentation neural network comprises an input image and wherein the generating the output of the instance segmentation neural network is based on the instance segmentation neural network minimizing a boundary loss, the boundary loss determined according to Lond=BCE(M, M_{gt}, W), where: L_{bnd} is the boundary loss, BCE( ) is a binary cross entropy function, M represents an output mask. M_{gt} is a ground truth mask, and W is a weight on each pixel of the input image.
Clause 17: The method of any of Clauses 1 through 16, further comprising generating a depth prediction prior to generating the output of the instance segmentation neural network.
Clause 18: The method of Clause 17, wherein the generating the depth prediction is based at least in part on minimization of a boundary mask loss, the boundary mask loss determined according to Lₘₐₛₖ=BCE(M_{pd}, M_{gt}>)+λBCE(M_{pd}^{sel},M_{gt}^{sel}), where: Lₘₐₛₖ is the boundary mask loss, BCE( ) is a binary cross entropy function, M_{pd} represents an output mask for all predicted pixels of the input image, M_{gt} is a ground truth mask for all ground truth pixels of the input image, M_{pd}^{sel} represents a mask for selected predicted pixels, and M_{gt}^{sel} represents selected ground truth pixels for the ground truth mask.
Clause 19: The method of any of Clauses 1 through 18, wherein the input to the instance segmentation neural network comprises an image for object detection.
Clause 20: A processor-implemented method comprising: generating a set of labels for an unlabeled training data set; and training an instance segmentation neural network based on the generated set of labels, wherein the instance segmentation neural network includes at least a first mask generation branch and a second mask generation branch, the second mask generation branch having a lower resolution than the first mask generation branch.
Clause 21: The method of Clause 20, wherein the generating the set of labels for the unlabeled training data set comprises using a transformer neural network trained to generate a mask and a classification for objects in images in the unlabeled training data set.
Clause 22: The method of Clause 20 or 21, wherein the training the instance segmentation neural network based on the generated set of labels comprises training the instance segmentation neural network to minimize a weighted boundary loss on a boundary of a target object in an input image of the unlabeled training data set.
Clause 23: The method of any of Clauses 20 through 22, wherein the training the instance segmentation neural network based on the generated set of labels comprises training the instance segmentation neural network to minimize a mask loss for an input image of the unlabeled training data set, the mask loss determined according to: Lₘₐₛₖ=BCE(M, M_{gt}), where: Lₘₐₛₖ is the mask loss, BCE( ) represents a binary cross entropy function, M represents a mask, and M_{gt} represents a ground truth mask.
Clause 24: The method of any of Clauses 20 through 23, wherein the training the instance segmentation neural network based on the generated set of labels comprises training the instance segmentation neural network to minimize a box regression loss for an input image of the unlabeled training data set, the box regression loss determined according to L_{box}=F(B_{pred}, B_{gt}), where: L_{box} is the box regression loss, F( ) represents a loss function of the second mask generation branch, B_{pred} represents a predicted box regression, and Bet represents a ground truth box regression.
Clause 25: The method of any of Clauses 20 through 24, wherein the training the instance segmentation neural network based on the generated set of labels further comprises training the instance segmentation neural network to minimize a classification loss for an input image of the unlabeled training data set, the classification loss determined according to L_{cls}=CE(Y_{pred}, Y_{gt}), where: L_{cls} is the classification loss, CE( ) is a cross entropy function, Y_{pred} is a predicted classification, and Yet is a ground truth classification.
Clause 26: The method of any of Clauses 20 through 25, wherein the training the instance segmentation neural network based on the generated set of labels comprises training the instance segmentation neural network to minimize a boundary loss for an input image of the unlabeled training data set, the boundary loss determined according to L_{bnd}=BCE(M, M_{gt}, W), where: L_{bnd} is the boundary loss, BCE( ) is a binary cross entropy function, M represents an output mask, M_{gt} is a ground truth mask, and W is a weight on each pixel of the input image.
Clause 27: The method of any of Clauses 20 through 26, wherein the training the instance segmentation neural network based on the generated set of labels further comprises training the instance segmentation neural network to minimize a boundary mask loss via a depth prediction module.
Clause 28: The method of Clause 27, wherein the boundary mask loss is determined according to Lₘₐₛₖ=BCE(M_{pd}, M_{gt})+λBCE(M_{pd}^{sel}, M_{gt}^{sel}), where: Lₘₐₛₖ is the boundary mask loss, BCE( ) is a binary cross entropy function, M_{pd} represents an output mask for all predicted pixels of the input image, M_{gt} is a ground truth mask for all ground truth pixels of the input image, M_{pd}^{sel} represents a mask for selected predicted pixels, and M_{gt}^{sel} represents selected ground truth pixels for the ground truth mask.
Clause 29: The method of any of Clauses 20 through 27, wherein the training the instance segmentation neural network based on the generated set of labels comprises training the instance segmentation neural network to minimize a loss of a Laplacian filter applied to a ground truth mask.
Clause 30: A processing system comprising: a memory comprising computer-executable instructions and one or more processors configured to execute the computer-executable instructions and cause the processing system to perform a method in accordance with any of Clauses 1-19 or 20-29.
Clause 31: A processing system, comprising means for performing a method in accordance with any of Clauses 1-19 or 20-29.
Clause 32: A non-transitory computer-readable medium comprising computer-executable instructions that, when executed by one or more processors of a processing system, cause the processing system to perform a method in accordance with any of Clauses 1-19 or 20-29.
Clause 33: A computer program product embodied on a computer-readable storage medium comprising code for performing a method in accordance with any of Clauses 1-19 or 20-29.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiples of the same element (e.g., a−a, a−a−a, a−a−b, a−a−c, a−b−b, a−c−c, b−b, b−b−b, b−b−c, c−c, and c−c−c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method comprising:
generating a first mask output from a first mask generation branch of an instance segmentation neural network, based on an input to the instance segmentation neural network;
generating a second mask output from a second mask generation branch of the instance segmentation neural network, based on the generated first mask output from the first mask generation branch, the second mask generation branch having a lower resolution than the first mask generation branch;
generating a combined mask output based on the generated first mask output from the first mask generation branch and the generated second mask output from the second mask generation branch;
generating an output of the instance segmentation neural network, based on the generated combined mask output; and
taking one or more actions based on the generated output of the instance segmentation neural network.

2. The method of claim 1, wherein at least part of the instance segmentation neural network is a convolutional neural network.

3. The method of claim 1, wherein the generated first mask output from the first mask generation branch has a higher resolution than the generated second mask output from the second mask generation branch.

4. The method of claim 3, further comprising upsampling the generated second mask output from the second mask generation branch to a same resolution as the generated first mask output from the first mask generation branch, prior to generating the combined mask output.

5. The method of claim 1, wherein the generated second mask output from the second mask generation branch is based on at least one mask coefficient determined for the first mask generation branch of the instance segmentation neural network.

6. The method of claim 1, further comprising generating a third mask output from a third mask generation branch, wherein the third mask generation branch has a lower resolution than the second mask generation branch, and wherein the combined mask output is generated further based on the generated third mask output.

7. The method of claim 1, further comprising generating a predicted bounding box around a target object in an image, prior to generating the output of the instance segmentation neural network, wherein the output includes the predicted bounding box around the target object and wherein the taking the one or more actions is further based on the predicted bounding box.

8. The method of claim 1, further comprising generating an output from a semantic segmentation branch of the instance segmentation neural network, prior to generating the output of the instance segmentation neural network, wherein the output from the semantic segmentation branch identifies portions of the input for which the instance segmentation neural network is to generate the combined mask output.

9. The method of claim 1, wherein the instance segmentation neural network is based on a YOLACT (You Only Look At CoefficientTs) neural network.

10. The method of claim 1, wherein the generating the combined mask output comprises concatenating the generated first mask output from the first mask generation branch with the generated second mask output from the second mask generation branch.

11. The method of claim 1, wherein the generated combined mask output comprises a mask for each instance of a target object identified in an input image by the instance segmentation neural network.

12. The method of claim 1, wherein the input to the instance segmentation neural network comprises an input image and wherein the generated output of the instance segmentation neural network comprises a boundary of at least one instance of a target object in the input image.

13. The method of claim 1, wherein the generating the output of the instance segmentation neural network is based on the instance segmentation neural network minimizing a mask loss, the mask loss determined according to: Lₘₐₛₖ=BCE(M, M_{gt}), where:
Lₘₐₛₖ is the mask loss,
BCE( ) represents a binary cross entropy function,
M represents a mask, and
M_{gt} represents a ground truth mask.

14. The method of claim 1, wherein the generating the output of the instance segmentation neural network is based on the instance segmentation neural network minimizing a box regression loss, the box regression loss determined according to L_{box}=F(B_{pred}, B_{gt}), where:
L_{box} is the box regression loss,
F( ) represents a loss function of the second mask generation branch,
B_{pred} represents a predicted box regression, and
B_{gt} represents a ground truth box regression.

15. The method of claim 1, wherein the generating the output of the instance segmentation neural network is based on the instance segmentation neural network minimizing a classification loss, the classification loss determined according to L_{cls}=CE(Y_{pred}, Y_{gt}), where:
L_{cls} is the classification loss,
CE( ) is a cross entropy function,
Y_{pred} is a predicted classification, and
Y_{gt} is a ground truth classification.

16. The method of claim 1, wherein the input to the instance segmentation neural network comprises an input image and wherein the generating the output of the instance segmentation neural network is based on the instance segmentation neural network minimizing a boundary loss, the boundary loss determined according to L_{bnd}=BCE(M, M_{gt}, W), where:
L_{bnd} is the boundary loss,
BCE( ) is a binary cross entropy function,
M represents an output mask,
M_{gt} is a ground truth mask, and
W is a weight on each pixel of the input image.

17. The method of claim 1, further comprising generating a depth prediction prior to generating the output of the instance segmentation neural network.

18. The method of claim 17, wherein the generating the depth prediction is based at least in part on minimization of a boundary mask loss, the boundary mask loss determined according to Lₘₐₛₖ=BCE(M_{pd}, M_{gt′})+λBCE(M_{pd}^{sel}, M_{gt}^{sel}), where:
Lₘₐₛₖ is the boundary mask loss,
BCE( ) is a binary cross entropy function,
M_{pd} represents an output mask for all predicted pixels of the input image,
M_{gt} is a ground truth mask for all ground truth pixels of the input image,
M_{pd}^{sel} represents a mask for selected predicted pixels, and
M_{gt}^{sel} represents selected ground truth pixels for the ground truth mask.

19. The method of claim 1, wherein the input to the instance segmentation neural network comprises an image for object detection.

20. A processor-implemented method comprising:
generating a set of labels for an unlabeled training data set; and
training an instance segmentation neural network based on the generated set of labels, wherein the instance segmentation neural network includes at least a first mask generation branch and a second mask generation branch, the second mask generation branch having a lower resolution than the first mask generation branch.

21. The method of claim 20, wherein the generating the set of labels for the unlabeled training data set comprises using a transformer neural network trained to generate a mask and a classification for objects in images in the unlabeled training data set.

22. The method of claim 20, wherein the training the instance segmentation neural network based on the generated set of labels comprises training the instance segmentation neural network to minimize a weighted boundary loss on a boundary of a target object in an input image of the unlabeled training data set.

23. The method of claim 20, wherein the training the instance segmentation neural network based on the generated set of labels comprises training the instance segmentation neural network to minimize a mask loss for an input image of the unlabeled training data set, the mask loss determined according to: Lₘₐₛₖ=BCE(M, M_{gt}), where:
Lₘₐₛₖ is the mask loss,
BCE( ) represents a binary cross entropy function,
M represents a mask, and
M_{gt} represents a ground truth mask.

24. The method of claim 20, wherein the training the instance segmentation neural network based on the generated set of labels comprises training the instance segmentation neural network to minimize a box regression loss for an input image of the unlabeled training data set, the box regression loss determined according to L_{box}=F(B_{pred}, B_{gt}), where:
L_{box} is the box regression loss,
F( ) represents a loss function of the second mask generation branch,
B_{pred} represents a predicted box regression, and
B_{gt} represents a ground truth box regression.

25. The method of claim 20, wherein the training the instance segmentation neural network based on the generated set of labels further comprises training the instance segmentation neural network to minimize a classification loss for an input image of the unlabeled training data set, the classification loss determined according to L_{cls}=CE(Y_{pred}, Y_{gt}), where:
L_{cls} is the classification loss,
CE( ) is a cross entropy function,
Y_{pred} is a predicted classification, and
Y_{gt} is a ground truth classification.

26. The method of claim 20, wherein the training the instance segmentation neural network based on the generated set of labels comprises training the instance segmentation neural network to minimize a boundary loss for an input image of the unlabeled training data set, the boundary loss determined according to L_{bnd}=BCE(M, M_{gt}, W), where:
L_{bnd} is the boundary loss,
BCE( ) is a binary cross entropy function,
M represents an output mask,
M_{gt} is a ground truth mask, and
W is a weight on each pixel of the input image.

27. The method of claim 20, wherein the training the instance segmentation neural network based on the generated set of labels further comprises training the instance segmentation neural network to minimize a boundary mask loss via a depth prediction module.

28. The method of claim 27, wherein the boundary mask loss is determined according to Lₘₐₛₖ=BCE(M_{pd}, M_{gt})+λBCE(M_{pd}^{sel}, M_{gt}^{sel}), where:
Lₘₐₛₖ is the boundary mask loss,
BCE( ) is a binary cross entropy function,
M_{pd} represents an output mask for all predicted pixels of the input image,
M_{gt} is a ground truth mask for all ground truth pixels of the input image,
M_{pd}^{sel} represents a mask for selected predicted pixels, and
M_{gt}^{sel} represents selected ground truth pixels for the ground truth mask.

29. The method of claim 20, wherein the training the instance segmentation neural network based on the generated set of labels comprises training the instance segmentation neural network to minimize a loss of a Laplacian filter applied to a ground truth mask.

30. A system comprising:
a memory having executable instructions stored thereon; and
a processor configured to execute the executable instructions in order to cause the system to:
generate a first mask output from a first mask generation branch of an instance segmentation neural network, based on an input to the instance segmentation neural network;
generate a second mask output from a second mask generation branch of the instance segmentation neural network, based on the generated first mask output from the first mask generation branch, the second mask generation branch having a lower resolution than the first mask generation branch;
generate a combined mask output based on the generated first mask output from the first mask generation branch and the generated second mask output from the second mask generation branch
generate an output of the instance segmentation neural network, based on the generated combined mask output; and
take one or more actions based on the generated output of the instance segmentation neural network.
